(19) United States
(12) Patent Application Publication
(10) Pub. No.: US 2026/0252440 A1
(43) Pub. Date: Aug. 27, 2026

(54) INPUT/OUTPUT MEMORY MANAGEMENT UNIT-BASED DATA INTEGRITY CONTROL

(71) Applicant: International Business Machines Corporation, Armonk, NY (US)

(72) Inventors: LUKE HOPKINS, Peterborough, NH (US); Michael James Becht, Poughkeepsie, NY (US); Sascha Junghans, Ammerbuch (DE); Raymond Wong, Hopewell Junction, NY (US); Matthias Klein, Poughkeepsie, NY (US)

(21) Appl. No.: 19/064,826

(22) Filed: Feb. 27, 2025

(51) Int. Cl. G06F 11/10; G06F 12/1009

(52) U.S. Cl. CPC G06F 11/1004; G06F 11/1064; G06F 12/1009

(57) ABSTRACT

A present invention embodiment provides a computer system including an input/output memory management unit (IOMMU) configured to perform address translation between an input/output (I/O) adapter and a system memory. The IOMMU comprises an address translation module and a checksum calculator configured to calculate checksums of direct memory access payloads exchanged between the I/O adapter and the system memory. The IOMMU includes a page table that stores virtual addresses for the I/O adapter. A set of bits is added to each virtual address to control checksum accumulation, checksum insertion, and caching of checksum contexts by the IOMMU.

### BACKGROUND

### 1. Technical Field

Present invention embodiments relate to computing hardware, and more specifically, to input/output memory management unit-based data integrity control.

### 2. Discussion of the Related Art

An Input/Output Memory Management Unit (IOMMU) is a hardware component that acts as a bridge between I/O adapters (e.g., network cards, graphics cards, storage controllers, etc.) and a system's main memory. An IOMMU may intercept Direct Memory Access (DMA) requests from I/O adapters and translate the virtual I/O addresses presented by I/O adapters into actual physical addresses in system memory. By managing these translations, the IOMMU consolidates address mappings and prevents I/O devices from accessing system memory regions that the I/O devices are not authorized to access.

### SUMMARY

According to one embodiment of the present invention, a computer system includes an input/output memory management unit (IOMMU) configured to perform address translation between an input/output (I/O) adapter and a system memory. The IOMMU comprises an address translation module and a checksum calculator configured to calculate checksums of direct memory access payloads exchanged between the I/O adapter and the system memory. The IOMMU includes a page table that stores virtual addresses for the I/O adapter. A set of bits is added to each virtual address to control checksum accumulation, checksum insertion, and caching of checksum contexts by the IOMMU.

### BRIEF DESCRIPTION OF THE DRAWINGS

Generally, like reference numerals in the various figures are utilized to designate like components.

FIG. 1 is a diagrammatic illustration of an example computing environment according to an embodiment of the present invention.

FIG. 2 is a block diagram of application code according to an embodiment of the present invention.

FIG. 3 is a block diagram of an environment including an IOMMU that performs checksum operations according to an embodiment of the present invention.

FIG. 4 is a block diagram depicting an example of checksum operations in relation to control bit fields according to an embodiment of the present invention.

FIG. 5 is a block diagram depicting an example of checksum operations in relation to control bit fields according to an embodiment of the present invention.

FIG. 6 is a flowchart of a method for performing IOMMU-based data integrity control according to an embodiment of the present invention.

### DETAILED DESCRIPTION

A present invention embodiment relates to data processing systems, and more specifically, to input/output memory management unit (IOMMU)-based data integrity control. A conventional IOMMU performs address translation and passes data (e.g., direct memory access (DMA) payloads) between I/O adapters and system memory. The address translation assigns virtual addresses, which are used by an I/O adapter, to physical addresses in the system memory, preventing I/O adapters from directly accessing the system memory's physical addresses.

In order to ensure data integrity, techniques involving checksums can be employed to generate compact, mathematical fingerprints of larger data sets, enabling systems to detect accidental or malicious alterations. When data is transferred or stored, a checksum such as a cyclic redundancy check (CRC) may be computed, and can appended to the data payload. Upon retrieval, the checksum is recomputed for the received data. If the newly-computed value matches the stored checksum, the data may be presumed to be intact; otherwise, a mismatch may indicate that errors or unauthorized modifications have occurred. In the context of IOMMUs, conventional IOMMUs do not support checksum insertion on data streams or validation of checksums.

The embodiments presented herein address this problem by implementing hardware in the IOMMU for performing checksums such as CRC. A hardware calculator module is included in an IOMMU that is configured to perform checksum operations on DMA payloads. These operations can include checksum accumulation (i.e., generation of checksums), checksum caching, and/or insertion of checksums in DMA payloads. In order to control when these operations are performed, control bits are added to a virtual address, with each control bit toggling a particular checksum operation to be performed. From the perspective of an I/O device, the control bits are simply treated as part of the virtual address, as the I/O device does not require knowledge of the purpose of the control bits.

Thus, present embodiments improve the technical field of computing by implementing hardware-level data integrity checks in IOMMUs. Unlike traditional solutions that perform CRC at the endpoint device or rely on software routines, this approach offloads the integrity checks to a centralized, low-latency hardware mechanism and eliminates the need for specialized device implementations. It also offers finer control over how and when CRC is applied, reducing overhead by allowing features like “scan-only” (skip) modes or dynamic toggling of CRC accumulation. Present invention embodiments provide several practical applications, including enhancing data reliability with minimal processing overhead (e.g., by offloading operations from a central processing unit), increasing data security, minimizing memory usage, and making the CRC protection mechanism transparent to higher software levels (e.g., by enabling checksums to be computed without storing the checksums).

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

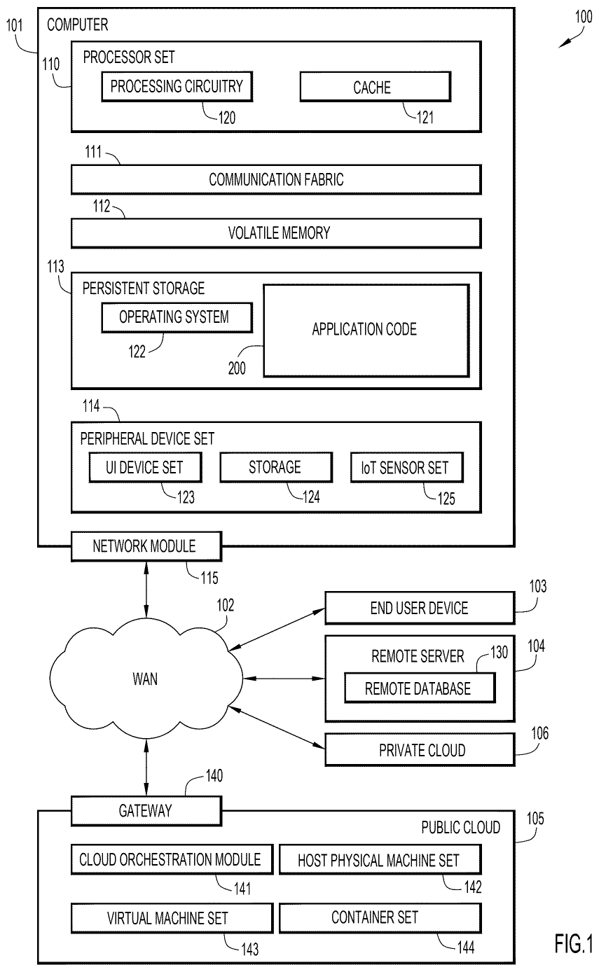

Referring to FIG. 1, computing environment 100 contains an example of an environment for the execution of at least some of the computer code involved in performing the inventive methods, such as application code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to an “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

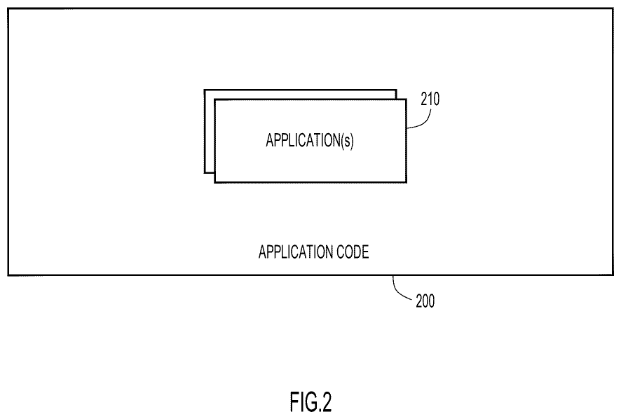

A block diagram of application code 200 according to an embodiment of the present invention is illustrated in FIG. 2. Specifically, application code 200 includes one or more applications 210. Application(s) 210 may include one or more modules or units to perform various functions of present invention embodiments described herein. Application(s) 210 may be implemented by any combination of any quantity of software and/or hardware modules or units, and may reside within volatile memory 112 of computer 101 for execution by a processor, such as processor set 110.

Application(s) 210 may include any software whose operations involve the exchange of data with an I/O adapter, such as a Peripheral Component Interconnect Express (PCIe) device or other I/O devices. Application(s) 210 may access system memory via an operating system, and the data in system memory can be exchanged with I/O adapters via an IOMMU as described herein.

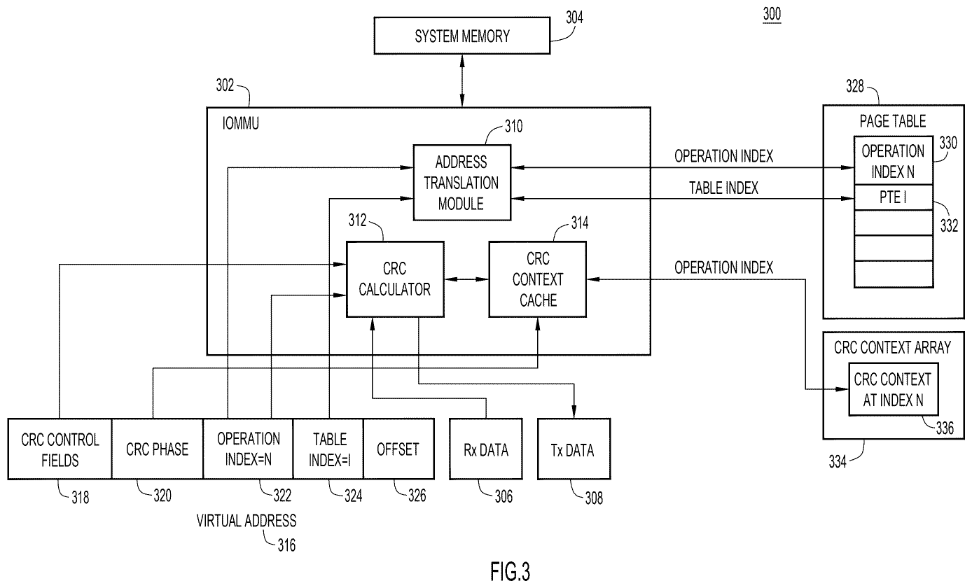

FIG. 3 is a block diagram of an environment 300 including an IOMMU that performs checksum operations according to an embodiment of the present invention. As depicted, environment 300 includes an IOMMU 302, and system memory 304. Also depicted is an example of a virtual address 316, a page table 328, a CRC context array 334, received (Rx) data 306, and transmitted (Tx) data 308. While the example of environment 300 utilizes CRC as a checksum technique, it should be appreciated that any other suitable checksum technique may similarly be implemented.

IOMMU 302 acts as a bridge between system memory 304 and one or more I/O adapters (not shown), from which IOMMU 302 receives received data 306 and transmits transmitted data 308. Address translation module 310 of IOMMU 302 translates virtual addresses, which are used by I/O adapters and associated with the received data 306 and transmitted data 308, into the physical addresses that are used by system memory 304. In order to map virtual addresses to physical addresses, address translation module 310 includes a page table 328 that tracks operations and includes corresponding page table entries for each operation in which the mappings of virtual to physical addresses are stored. The operation index 330 (i.e., “N”) indicates that the corresponding page table entries 332 (i.e., “PTE 1”) are associated with a particular DMA operation. As an operation can span multiple pages of memory, there may be multiple corresponding page table entries. Each page table entry may include a mapping of a virtual address to a physical address, which are used by address translation module 310 to translate addresses.

CRC calculator 312 is a hardware component of IOMMU 302 that performs checksum operations, including generating checksums for both Tx and Rx data, inserting checksums in Tx data, and responding to control bit values in virtual addresses. CRC calculator 312 may calculate CRC values by mathematically processing DMA payload data. In particular, CRC values may be generated by performing polynomial division on the payload data. The CRC technique that is employed can include CRC-8, CRC-16, CRC-32, CRC-64, and/or other CRC techniques. However, in other embodiments, checksums other than CRCs may be generated.

CRC context cache 314 includes a cache for storing CRC contexts based on the phase indicated in the control bits. As such, CRC context cache 314 acts as a buffer in IOMMU 302 that stores partial/in-progress CRC states associated with each operation index. The phase indicates to IOMMU 302 whether to continue using an existing CRC context or to start a new context. Thus, CRC values may be stored in CRC context cache 314 that are used to compare to newly-accumulated CRC values. Thus, when a phase changes, CRC calculator 312 can finalize one data block and begin accumulating a fresh CRC. The phase ensures that a new CRC context is read into cache when a new operation is started. CRC context cache 314 includes cached CRC contexts from the CRC Context Array in memory. A CRC context array 334 stores CRC contexts 336 by their index values (e.g., operation index “N” in the depicted example).

Virtual address 316 is an example virtual address that includes CRC control fields 318, CRC phase 320, operation index field 322, table index field 324, and offset 326. Whereas a conventional virtual address includes table indexes and an offset,, virtual address 316 has been augmented in accordance with present embodiments to also include CRC control fields 318 and CRC phase 320 to indicate to IOMMU 302 the particular instructions for handling CRC operations for a particular DMA. Additionally the virtual address has been augmented with an operation index which identifies a CRC context. This index can be used to segment the set of leaf indexes.

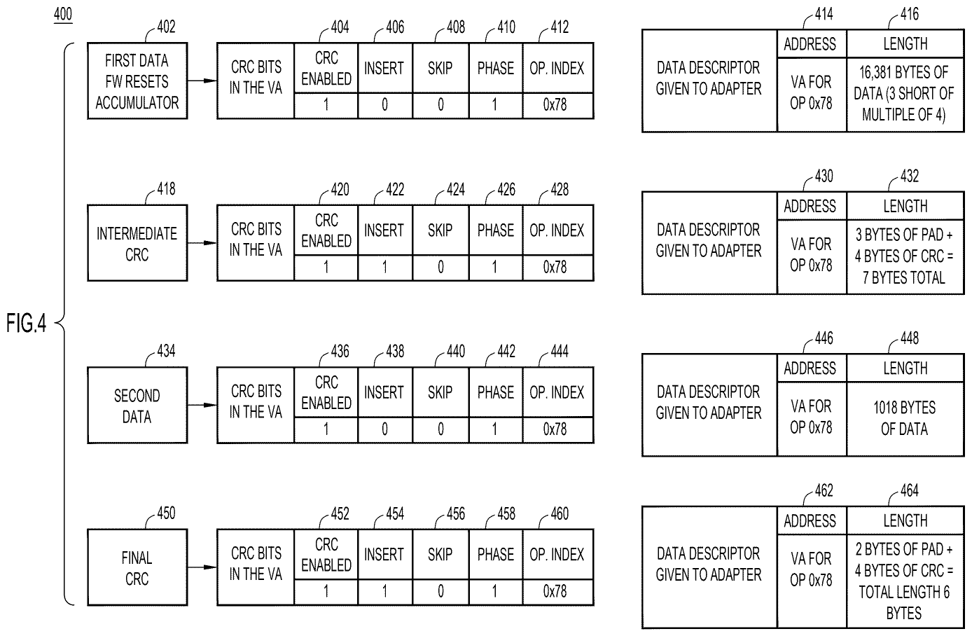

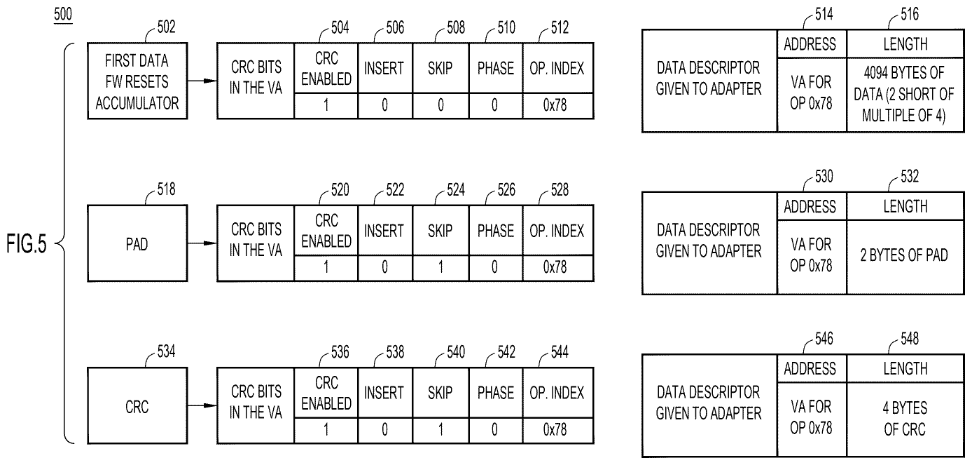

CRC control fields 318 may include control bits that indicate whether to perform accumulation, to insert a CRC, and/or to skip data, as is explained in further detail below with reference to FIGS. 4 and 5. CRC phase 320 indicates a phase change has occurred; CRC phase 320 can be implemented as a single bit, that, when changed, indicates that a next phase has begun for CRC caching purposes. Operation index field 322 indicates the operation (“N”) and table index field 324 indicates the table index (“I”) in page table 328 so that address translation module 310 can translate the virtual address to the physical address, and offset 326 indicates the byte offset in a page in which the particular address can be found.

Thus, in addition to performing address translation, IOMMU 302 is configured to accumulate CRCs, insert CRCs, cache CRCs, compare CRCs in order to perform data integrity checks, and to optionally compute CRC without moving receive data to memory. The comparison is preferably performed by firmware, but in one embodiment, the hardware could compare the expected and calculated CRC values.

FIG. 4 is a block diagram depicting an example of checksum operations 400 in relation to control bit fields according to an embodiment of the present invention. The checksum operations 400 may correspond to a write operation, and the checksums may include four-byte CRCs.

Initially, control bits 402 are four bits that include a CRC enabled bit 404, an insert bit 406, a skip bit 408, and a phase bit 410 for an operation having an operation index 412 of 0x78. CRC enabled bit 404 is set to “1”, indicating that CRC accumulation should be performed. Insert bit 406 is set to “0”, indicating that the CRC value will not be inserted into the DMA payload, but will instead be internally tracked by the IOMMU. Skip bit 408 is set to “0”, meaning that the payload data is being transferred (i.e., transferred from memory to the I/O adapter). Phase bit 410 is set to “1” to define a current phase; a previous operation would include a value of “0”, so the change to “1” indicates that a new operation is being performed. The data descriptor given to the adaptor includes an address 414 (the virtual address for operation 0x78) and the data length 416 (e.g., “16,381 bytes”, an example payload size, which is three bytes short of a multiple of 4). Thus, the IOMMU accumulates CRC across these 16,381 bytes. No CRC is appended yet, so the I/O adapter may only receive the pure payload. Additionally, the partial CRC state is cached in the CRC context cache for operation index 0x78.

Control bits 418 correspond to an intermediate CRC and include a CRC enabled bit 420, an insert bit 422, a skip bit 424, and a phase bit 426 associated with an operation index 428 of 0x78 (i.e., the same operation). CRC enabled bit 420 remains “1”, indicating that CRC is being performed. Insert bit 422 has a value of “1”, indicating that the IOMMU will insert the CRC at the end of the data stream which was begun by the first virtual address 402 (and the subsequent PCI transactions leading up to 418). Skip bit 424 has a value of “0”, indicating that the data is being transferred to the IO device. Skip pertains to whether data is moved to its destination (I/O device (Tx) or memory (Rx)) while the CRC computation is taking place. However, as the payload has been transferred at the previous step, the only data left to transfer at this step is the CRC block and three-byte pad which is inserted by the IOMMU hardware, for a total of 16,388 bytes, which is divisible by four, since CRC must be 4 byte aligned. The phase bit 426 remains set to “1”, indicating that a phase change has not occurred, and the operation index 428 remains 0x78. The data descriptor given to the adapter includes a same address 430 (0x78) and the data length 432 includes three bytes of pad (e.g., “000”) plus the four bytes of the CRC itself for a total of 7 bytes, which, when added to the 16,381 bytes previously transmitted, totals 16,388 bytes, which is divisible by four and therefore 4-byte-aligned.

Control bits 434 correspond to a second data transfer and include a CRC enabled bit 436 of “1”, an insert bit 438 of “0”, a skip bit 440 of “0”, and a phase bit 442 of “1” for the same operation index 444 (“0x78”). Thus, CRC is enabled, accumulation is performed without inserting a CRC at the end of the block, the data is being transferred to the I/O adapter, and the phase has not changed. The data descriptor given to the I/O adapter includes a same address 446 and a data length 448 of 1018 bytes. Thus, the CRC is being accumulated for the same context, and since the CRC is not inserted, the payload is 1018 bytes.

Control bits 450 correspond to a final CRC and include a CRC enabled bit 452 of “1”, an insert bit 454 of “1”, a skip bit 456 of “0”, and a phase bit 458 of “1” for the same operation index 460 (“0x78”). Thus, CRC is enabled, the IOMMU will finalize the second data block's CRC and append the value, the final block (which consists of the pad and CRC) will be transferred, and the phase is the same. The data descriptor given to the I/O adapter includes a same address 462 and a data length 464 of 6 bytes. Thus, the 6 bytes, when appended to the 1018 bytes, results in a total of 1024 (which is divisible by four) to ensure that the CRC is 4-byte-aligned. Thus, the I/O adapter has received 17,412 bytes in total (17,399 of customer data+13 bytes for pad and CRC across the two insertion steps), which is divisible by four.

FIG. 5 is a block diagram depicting an example of checksum operations 500 in relation to control bit fields according to an embodiment of the present invention. The checksum operations 500 may correspond to a read operation of a 4094-byte payload that the IOMMU reads from the I/O adapter. The IOMMU uses the CRC to verify the incoming data.

Control bits 502 correspond to a first data that resets the accumulator function, and include a CRC enabled bit 504 of “1”, an insert bit 506 of “0”, a skip bit 508 of “0”, and a phase bit 510 of “0” for an operation index 512 of 0x78. Thus, CRC is enabled, the IOMMU will not add a CRC to the data, but instead will merely perform CRC accumulation, and the data is written to memory (so the full 4094 bytes of the read operation are transferred to memory). Since the phase is 0 and the previous operation had a phase of 1, the IOMMU pulls in a fresh CRC context into the CRC context cache for the operation 0x78. The data descriptor given to the I/O adapter includes the address 514 (the virtual address for operation 0x78) and a data length 516 of 4094 bytes (which is two bytes short of a multiple of four).

Control bits 518 correspond to a pad that is necessary to round out the data length, and include a CRC enabled bit 520 of “1”, an insert bit 522 of “0”, a skip bit 524 of “1”, and a phase bit 526 of “0” for the same operation index 528 of 0x78. Thus, CRC is enabled, the IOMMU will not add a CRC to the data, and the data is read from the device but not written to memory (as the pad bytes are used by the IOMMU to update the CRC and discarded before providing the data to host memory). The phase is unchanged, indicating that the same CRC context is still active. Here, the IOMMU reads the 2 pad bytes, updates the CRC calculation accordingly, and discards the data. The data descriptor given to the I/O adapter includes the address 530 (the virtual address for operation 0x78) and a data length 532 of 2 bytes (which is the pad).

Control bits 534 correspond to the CRC, and include a CRC enabled bit 536 of “1”, an insert bit 538 of “0”, a skip bit 540 of “1”, and a phase bit 542 of “0” for the same operation index 544 of 0x78. Thus, CRC is enabled, the IOMMU will not add a CRC to the data (as these four bytes are coming from the device), and the data is read from the device but not written to memory (as the CRC bytes are used to verify against an internally-accumulated CRC). The phase is unchanged, indicating that the same CRC context is still active. The data descriptor given to the I/O adapter includes the address 546 (the virtual address for operation 0x78) and a data length 548 of 4 bytes (which is the CRC). Thus, an end-to-end integrity check may be performed on the inbound data using the IOMMU's hardware CRC logic.

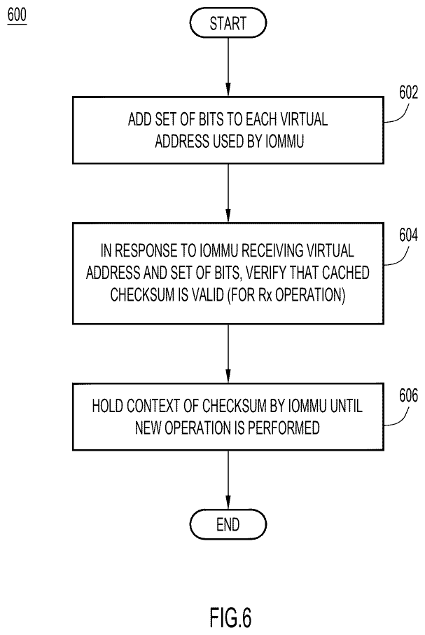

FIG. 6 is a flowchart of a method 600 for performing IOMMU-based data integrity control according to an embodiment of the present invention.

A set of bits is added to each virtual address used by an IOMMU at operation 602. A small set of control bits (e.g., four bits) is added to each virtual address that the IOMMU uses for translating device addresses to system memory. The values of these bits may dictate how the IOMMU performs checksums using a hardware module associated with the IOMMU. In particular, the control bit values indicate whether the IOMMU should accumulate a checksum, insert a computed checksum into a data payload, cache a partial checksum state, or skip placement of the data in its final destination and only accumulate the CRC.

In response to the IOMMU receiving a virtual address that includes a set of control bits, the cached checksum is verified at operation 604. The checksum is verified on an Rx operation. On a Tx operation, the checksum is generated, but not verified, by the IOMMU. The IOMMU doesn't know when the operation ends. However, the firmware knows when the operation ends and uses the information in the CRC context to verify the checksum on an Rx operation. The firmware is informed that the operation has ended and can then compare the checksum reported by the I/O device against the accumulated checksum in the CRC context. Note that the CRC context includes the current CRC, the previous CRC value and the last four bytes of the current payload. This way the firmware compares the previous CRC with the last 4 bytes of the payload when it's checking the CRC of a received data block. Whenever the IOMMU receives a virtual address from either the I/O adapter or system memory, the IOMMU analyzes the extra bits. Based on these bits, the IOMMU decides whether to update an existing checksum calculation (accumulate) or to physically insert the checksum into the data stream. The IOMMU may also verify that any previously-cached checksum state remains valid for the current operation.

The context of the checksum is held by the IOMMU until a new operation is performed at operation 606. The IOMMU stores the in-progress checksums in a local context cache. This cached context is preserved and reused for multiple DMA transfers, enabling continuous checksum accumulation. When a particular bit is changed to indicate a new DMA operation is now in progress, the IOMMU may reinitialize or switch to a fresh checksum context.

It will be appreciated that the embodiments described above and illustrated in the drawings represent only a few of the many ways of implementing embodiments for input/output memory management unit-based data integrity control.

The environment of the present invention embodiments may include any number of computer or other processing systems (e.g., any computing device, computing service, etc.) and databases or other repositories arranged in any desired fashion, where the present invention embodiments may be applied to any desired type of computing environment (e.g., cloud computing, client-server, network computing, mainframe, stand-alone systems, etc.). The computer or other processing systems employed by the present invention embodiments may be implemented by any number of any personal or other type of computer or processing system. These systems may include any types of monitors and input devices (e.g., keyboard, mouse, voice recognition, etc.) to enter and/or view information.

It is to be understood that the software of the present invention embodiments (e.g., application code 200, application(s) 210, etc.) may be implemented in any desired computer language and could be developed by one of ordinary skill in the computer arts based on the functional descriptions contained in the specification and flowcharts illustrated in the drawings. Further, any references herein of software performing various functions generally refer to computer systems or processors performing those functions under software control. The computer systems of the present invention embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present invention embodiments may be distributed in any manner among the various end-user/client, distributed computing, and server systems, and/or any other intermediary processing devices. The software and/or algorithms described above and illustrated in the flowcharts may be modified in any manner that accomplishes the functions described herein. In addition, the functions in the flowcharts or description may be performed in any order that accomplishes a desired operation.

The communication network may be implemented by any number of any type of communications network (e.g., LAN, WAN, Internet, Intranet, VPN, etc.). The computer or other processing systems of the present invention embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The system may employ any number of any conventional or other databases, data stores or storage structures (e.g., files, databases, data structures, data or other repositories, etc.) to store information. The database system may be implemented by any number of any conventional or other databases, data stores or storage structures (e.g., files, databases, data structures, data or other repositories, etc.) to store information. The database system may be included within or coupled to the computing system. The database systems and/or storage structures may be remote from or local to the computer or other processing systems, and may store any desired data.

The present invention embodiments may employ any number of any type of user interface (e.g., Graphical User Interface (GUI), command-line, prompt, etc.) for obtaining or providing information (e.g., application data, data processed by environment 300, etc.), where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

The application data, data processed by environment 300, and/or any other data may include any information arranged in any fashion, and may be configurable based on rules or other criteria to provide desired information to a user.

The present invention embodiments are not limited to the specific tasks or algorithms described above, but may be utilized for verifying data integrity using an IOMMU.

The data may include any format of storing data and may include any data descriptive of databases, including metadata and indexes thereof. The data may be obtained via any techniques, and may be accessed over a network, fetched from local storage, provided via user input, and the like.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes”, “including”, “has”, “have”, “having”, “with” and the like, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer system comprising:
an input/output memory management unit (IOMMU) configured to perform address translation between an input/output (I/O) adapter and a system memory, wherein the IOMMU comprises an address translation module and a checksum calculator configured to calculate checksums of direct memory access payloads exchanged between the I/O adapter and the system memory,
wherein the IOMMU includes a page table that stores virtual addresses for the I/O adapter, and
wherein a set of bits is added to each virtual address to control checksum accumulation, checksum insertion, and caching of checksum contexts by the IOMMU.

2. The computer system of claim 1, wherein the checksum comprises a Cyclic Redundancy Check (CRC).

3. The computer system of claim 1, wherein the set of bits includes four bits comprising a first bit that indicates whether to perform a checksum, a second bit that indicates whether to cache a checksum context, a third bit that controls hardware checksum insertion, and a fourth bit that indicates to accumulate the checksum without placing a direct memory access payload.

4. The computer system of claim 1, wherein a pad of bits is added to the virtual address along with the set of bits, and wherein a length of the pad of bits is selected such that a total number of bits of the virtual address, the pad, and the set of bits is divisible by four.

5. The computer system of claim 1, wherein the IOMMU further comprises a checksum context cache module that is configured to store checksum contexts.

6. The computer system of claim 1, wherein the IOMMU is configured to enable firmware to validate an accumulated checksum at an end of an operation through values saved in a context associated with the accumulated checksum.

7. The computer system of claim 1, wherein the I/O adapter comprises a Peripheral Component Interconnect Express (PCIe) device.

8. A computer-implemented method comprising:
adding a set of bits to each virtual address used by an IOMMU that performs address translation between an I/O adapter and a system memory, wherein the set of bits controls checksum accumulation, checksum insertion, and caching of checksum contexts by the IOMMU;
in response to the IOMMU receiving a particular virtual address and added set of bits from the I/O adapter or the system memory, verifying, by the IOMMU, based on the set of bits, that a cached checksum is valid and determining, based on the set of bits, to accumulate or insert the checksum; and
holding, by the IOMMU, a context of the checksum in local cache memory for multiple direct memory access transactions until the set of bits is updated to indicate that a new direct memory access operation is being performed.

9. The computer-implemented method of claim 8, wherein the checksum comprises a Cyclic Redundancy Check (CRC).

10. The computer-implemented method of claim 8, wherein the set of bits includes four bits comprising a first bit that indicates whether to perform a checksum, a second bit that indicates whether to cache a checksum context, a third bit that controls hardware checksum insertion, and a fourth bit that indicates to accumulate the checksum without placing a direct memory access payload.

11. The computer-implemented method of claim 8, wherein a pad of bits is added to the virtual address along with the set of bits, and wherein a length of the pad of bits is selected such that a total number of bits of the virtual address, the pad, and the set of bits is divisible by four.

12. The computer-implemented method of claim 8, wherein the IOMMU further comprises a checksum context cache module that is configured to store checksum contexts.

13. The computer-implemented method of claim 8, wherein the IOMMU is configured to enable firmware to validate an accumulated checksum at an end of an operation through values saved in the context of the checksum.

14. The computer-implemented method of claim 8, wherein the I/O adapter comprises a Peripheral Component Interconnect Express (PCIe) device.

15. A computer program product comprising:
one or more computer-readable storage media for an IOMMU; and
program instructions stored on the one or more computer-readable storage media to perform operations comprising:
adding a set of bits to each virtual address used by the IOMMU that performs address translation between an I/O adapter and a system memory, wherein the set of bits controls checksum accumulation, checksum insertion, and caching of checksum contexts by the IOMMU;
in response to the IOMMU receiving a particular virtual address and added set of bits from the I/O adapter or the system memory, verifying based on the set of bits, that a cached checksum is valid and determining, based on the set of bits, to accumulate or insert the checksum; and
holding a context of the checksum in local cache memory for multiple direct memory access transactions until the set of bits is updated to indicate that a new direct memory access operation is being performed.

16. The computer program product of claim 15, wherein the checksum comprises a Cyclic Redundancy Check (CRC).

17. The computer program product of claim 15, wherein the set of bits includes four bits comprising a first bit that indicates whether to perform a checksum, a second bit that indicates whether to cache a checksum context, a third bit that controls hardware checksum insertion, and a fourth bit that indicates to accumulate the checksum without placing a direct memory access payload.

18. The computer program product of claim 15, wherein a pad of bits is added to the virtual address along with the set of bits, and wherein a length of the pad of bits is selected such that a total number of bits of the virtual address, the pad, and the set of bits is divisible by four.

19. The computer program product of claim 15, wherein the IOMMU comprises a checksum context cache module that is configured to store checksum contexts.

20. The computer program product of claim 15, wherein the IOMMU is configured to enable firmware to validate an accumulated checksum at an end of an operation through values saved in the context of the checksum.
